(19) United States
(12) Patent Application Publication
(10) Pub. No.: US 2011/0205211 A1
(43) Pub. Date: Aug. 25, 2011

(54) IMAGE DISPLAY APPARATUS

(75) Inventors: Koichi Sakai, Kashiwa-shi (JP); Kinya Kamiguchi, Kamakura-shi (JP)

(73) Assignee: CANON KABUSHIKI KAISHA, Tokyo (JP)

(21) Appl. No.: 13/030,642

(22) Filed: Feb. 18, 2011

(30) Foreign Application Priority Data
Feb. 19, 2010 (JP) 2010-035250

(51) Int. Cl. G09G 5/00

(52) U.S. Cl. 345/211; 345/204

(57) ABSTRACT

An image display apparatus which can reduce temperature rise and temperature variation in the heating elements in the housing, and is compatible with vertical arrangement and horizontal arrangement of a display screen without causing malfunction and image quality degradation is provided. The image display apparatus includes a control unit configured to control the air warmed up by the heating elements to flow in the vertical direction. The control unit is located closer to the center of the image display apparatus than the heating elements. The control unit includes a rotation plate that is rotated to maintain a longitudinal direction of the rotation plate parallel with the vertical direction according to rotation of the image display apparatus around the normal line as a rotation axis.

### BACKGROUND OF THE INVENTION

1. Field of the Invention

The present invention relates to an image display apparatus capable of disposing a display screen in a vertical or a horizontal direction.

2. Description of the Related Art

As a thin display panel used in an image display apparatus, there is a plasma display panel (PDP), a liquid crystal display panel (LCD), a field emission display panel (FED), and an organic light emitting display panel (OLED).

Generally, a flat panel display apparatuses (FPD) using a thin display panel has been required to achieve higher definition, higher brightness, and thinner display panel based on demand for quality improvement and space saving. Under such circumstances, a heat generation density in a housing including the display panel tends to increase. Increase in temperature of heating elements as exemplified by a driver integrated circuit (IC) for driving the display panel may cause improper operation and image quality deterioration.

Japanese Patent Application Laid-Open No. 11-242442 discusses providing a heat-releasing groove formed in a vertical direction on a chassis fixed between a back side of a PDP and a cover body thereof. The heat-releasing groove serves as a heat releasing path to guide the heat generated in the cover body disposed on the back side of the PDP upward in a vertical direction.

Generally, FPDs have a display screen with an aspect ratio of larger than 1:1. Recently, it has been discussed changing the orientation of the display screen according to various uses and displayed images as exemplified by digital signage. More specifically, the display screen of the FPD may be horizontally orientated in which the display screen is longer in a direction perpendicular to the vertical direction (horizontal arrangement), or may be vertically oriented in which the display screen is longer in the vertical direction (vertical arrangement).

If the FPD according to Japanese Patent Application Laid-Open No. 11-242442 is rotated 90 degrees around a normal line passing through the center of the screen of the display panel, for example, the heat releasing path is not formed upward in the vertical direction, and a flow of the heat may be blocked, resulting in deterioration of the head releasing performance.

To prevent the above problem, if a heat releasing groove is formed in the horizontal direction of the display screen, in addition to that in the vertical direction, an air flow is generated in the horizontal direction, and thus the upward air flow in the vertical direction may be reduced or may be fanned by the heat from the heating elements arranged adjacent in the horizontal direction. As a result, the temperature of the heating elements or temperature variation among the heating elements may increase, and malfunction and image degradation of the FPD may be caused.

To reduce this problem, to additionally install a heat releasing component, such as a fan or a heat sink, or to increase the space around the heating elements can be thought as a measure. However, such countermeasure will increase the weight, volume, and cost of the FPD and will significantly lower the competitiveness of the product.

### SUMMARY OF THE INVENTION

The present invention is directed to providing a flat panel display apparatus (FPD) capable of reducing temperature rise and temperature variation among heating elements if the FPD is rotated around a normal line of a display screen as a rotational axis.

According to an aspect of the present invention, an image display apparatus includes a display panel, a plurality of heating elements electrically connected to the display panel, a housing configured to cover the display panel and the plurality of the heating elements, and a control unit which is provided between a back side of the display panel which is a side opposite to a display screen of the display panel and the housing and is configured to control an air warmed up by the plurality of the heating elements to flow in a vertical direction, wherein the control unit is located closer to the center of the image display apparatus than the plurality of the heating elements, and, in a condition that a normal line to the display screen intersects the vertical direction, the control unit includes a rotation plate that is rotated to maintain a longitudinal direction of the rotation plate parallel with the vertical direction according to rotation of the image display apparatus around the normal line as a rotation axis.

According to exemplary embodiments of the present invention, a heat-releasing path can be formed to upward in the vertical direction regardless of the vertical or horizontal arrangement of the image display apparatus. Therefore, the image display apparatus can be provided which can reduce temperature increase and temperature variation among the heating elements if the image display apparatus is rotated.

Further features of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIGS. 1A to 1D are schematic diagrams illustrating an example of an image display apparatus according to first exemplary embodiment of the present invention.

FIG. 2 is a schematic diagram illustrating the image display apparatus as seen from a direction of an arrow in FIG. 1A.

FIG. 3 is a perspective view schematically illustrating a rotation plate.

FIGS. 4A to 4D illustrate schematic plan views of the rotation plates.

FIGS. 5A and 5B are schematic diagrams illustrating an image display apparatus according to second exemplary embodiment of the present invention.

FIGS. 6A and 6B are schematic diagrams illustrating an image display apparatus according to third exemplary embodiment of the present invention.

FIGS. 7A and 7B are comparison of average temperature and temperature variation of heating elements according to presence or absence of the rotation plate.

### DETAILED DESCRIPTION OF THE EMBODIMENTS

Various exemplary embodiments, features, and aspects of the invention will be described in detail below with reference to the drawings.

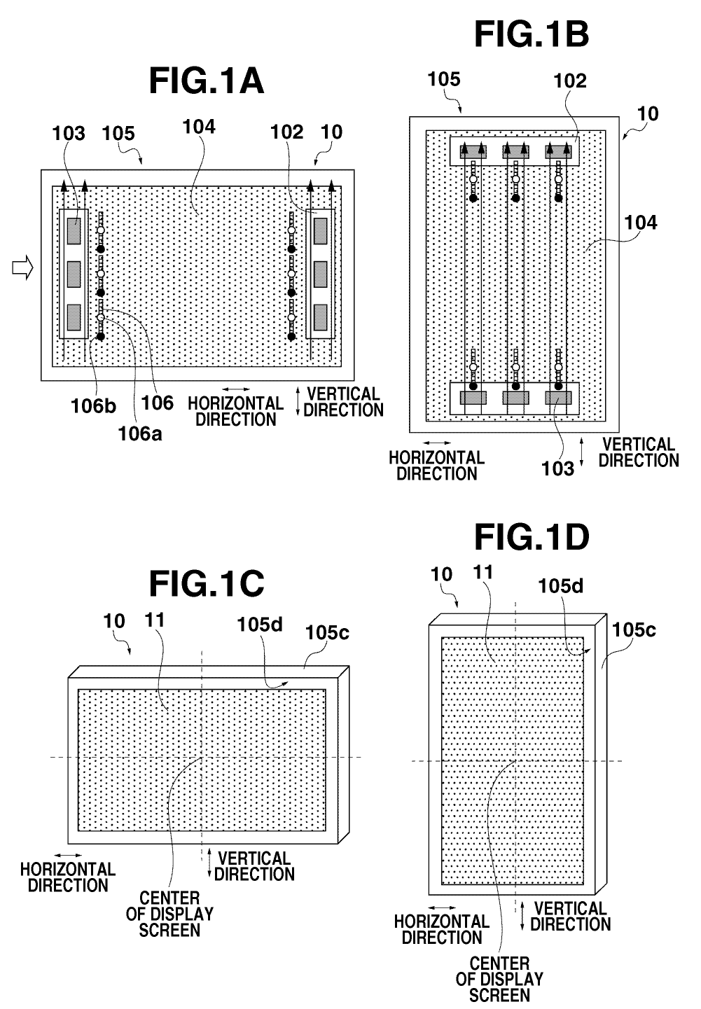

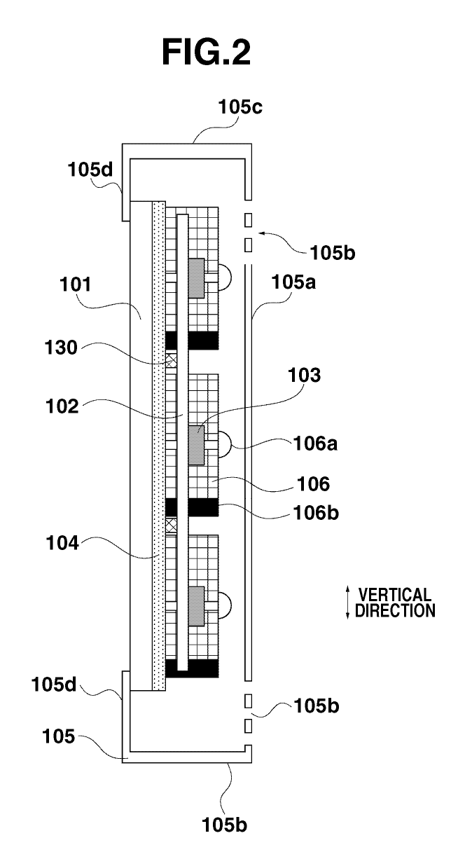

An image display apparatus, i.e. a flat panel display apparatus, using a thin display panel according to a first exemplary embodiment of the present invention will be described with reference to FIG. 1A to FIG. 1D, and FIG. 2. An FPD 10 in the present exemplary embodiment refers to a display apparatus capable of displaying various types of images, such as television broadcasted images, external input images input from a computer and a digital versatile disk (DVD) source, advertisements, medical images, guide images, and paintings.

The FPD 10 includes a display module, and a housing 105 to cover the display module. The display module includes at least a display panel 101, a circuit board 102 electrically connected to the display panel 101, and a plurality of heating elements 103, such as a driver IC, transistors, and a high-voltage power source. Other heating elements 103 may include a memory, a capacitor, a drive power supply field programmable gate array (FPGA), and an application specific integrated circuit (ASIC).

As the display panel 101, a flat display panel, such as a PDP, a LCD, a FED, or an OLED, can be used. The display module can further include a chassis to fix the display panel 101 to and to support the circuit board 102. Therefore, in this case, the chassis 104 supports the heating elements 103. If the display panel 101 has sufficient strength, the chassis 104 can be omitted. In this case, the plurality of the heating elements 103 and the circuit board 102 are supported by the display panel 101 or by the housing 105.

The FPD 10 includes a control unit configured to control air flow warmed up by the plurality of the heating elements 103 in the housing 105 to flow in a vertical direction. The control unit is provided between a back side of the display panel (on a side opposite to a display surface of the display panel 101) and the housing 105. The control unit is located closer to the center of the FPD than the plurality of the heating elements 103. If the heating elements 103 are located close to the center of the FPD, the control unit can be located between the heating elements 103 and an outer periphery of the FPD (between the heating elements and a side surface of the housing 105.)

The control unit includes at least a rotation plate 106. The rotation plate 106 is located close to the heating elements 103, and rotated as the FPD 10 rotates (to the vertical arrangement or the horizontal arrangement). As will be described below, the control unit may include a flow rectifying plate whose longitudinal direction is fixed, instead of the rotation plates 106 for rotating.

In the present exemplary embodiment, the housing 105 includes at least a back-side portion 105a to cover the back side of the display module, a lateral-side portion to cover the lateral side of the display module, and a front-side portion (bezel) 105d to cover the front portion of the display module.

The housing 105 further includes a plurality of openings 105b for ventilation. The openings 105b can let air flow from the outside into the inside of the housing (into a gap between the housing 105 and the display panel 101), and to let hot air warmed up in the housing 105 flow out to the housing 105. The openings 105b are preferably located at upper and lower positions in a vertical direction both in the state that the FPD 10 is in the horizontal arrangement and in the vertical arrangement. More specifically, it is desirable that the openings 105b are arranged at the left, right, top, and bottom of the peripheral area of the back side portion 105a of the housing 105, except for the center area. In many cases, the front side portion 105d of the housing 105 is not provided in an area faces the display screen of the display panel 101. However, in some case, a visible light transparent material is disposed on a portion facing the display screen. In this case, the housing 105 is configured to cover the whole display module.

FIG. 1A is a schematic plan view when the FPD 10 is seen from the back side under the condition that the FPD 10 is in the horizontal arrangement, similar to FIG. 1C. FIG. 1C is a schematic perspective view of the FPD 10 in FIG. 1A as seen from the front side (the display screen side). Similar to FIG. 1D, FIG. 1B is a schematic plan view of the FPD 10 as seen from the back side under the condition that the FPD 10 is in the vertical arrangement. FIG. 1D is a schematic perspective view of the FPD 10 in FIG. 1B as seen from the front side. For convenience of illustration, the back side portion 105b as a part of the housing 105 covering the display module is omitted both in FIGS. 1A and 1B.

On the other hand, FIG. 2 is a schematic view of the FPD 10 as seen from a direction of an arrow in FIG. 1A. In FIG. 2, for convenience of illustration of the inside of the housing 105, a part of the lateral side portion 105c as a part of the housing 105 covering the display module is omitted. In actuality, there is a flexible print circuit board connecting between the circuit board 102 and the display panel 101, but the flexible print circuit board is omitted for convenience of illustration.

The “vertical arrangement” represents the state that the long side of the FPD 10 is along the vertical direction. In other words, the vertical arrangement means that the FPD 10 is arranged in such a way that the display screen 11 of the FPD 10 is long in the vertical direction. The “horizontal arrangement” represents the state that the long side of the FPD 10 is along a direction perpendicular to the vertical direction, that is the horizontal direction. In other words, the horizontal arrangement that means that the FPD 10 is arranged in such a way that the display screen 11 of the FPD 10 is long in the direction perpendicular to the vertical direction, i.e. the horizontal direction.

The “vertical arrangement” is the state that the FPD 10 is rotated 90 degrees from the “horizontal arrangement” clockwise or counterclockwise around a normal line to the display screen 11, which passes through the center of the display screen 11. Needless to say, an aspect ratio of the display screen 11 of the FPD 10 is not 1:1. (The typical aspect ratio is 16:9.) When the FPD 10 is positioned in the horizontal arrangement or the vertical arrangement, the normal line to the display screen intersects the vertical direction in both cases. Generally, the vertical arrangement and the horizontal arrangement generally indicate conditions that the normal line to the display screen is approximately perpendicular to the vertical direction.

The display panel 101 includes a plurality of image display elements, and wiring connected to each of the image display elements. Each image display element is electrically connected to the circuit board 102 via a flexible print circuit board (FPC) connected to the wiring. If the display panel 101 is an FED, for example, each image display element includes an electron emissive element and a luminous element which emits light on receiving an electron from the electron emissive element. As the electron emissive element of the FED, there are a field emission type electron emissive element, a surface conduction electron emissive element, and a metal-insulator-metal (MIM) type electron emissive element.

FIGS. 1A and 1B schematically illustrate the circuit boards 102. Generally, the circuit board 102 is provided between the back side of the display panel 101 and the back-side portion 105a of the housing 105. However, the circuit board 102 may be provided between the lateral side of the display panel 101 and the lateral-side portion 105c of the housing 105. The heating elements 103, such as the driver IC, may also be provided between the lateral side of the display panel 101 and the lateral-side portion 105c of the housing 105.

Generally, an FPC is used for wiring to connect between the circuit board 102 and the display panel 101. In this case, generally, one end of the FPC is connected to the display panel 101 at the lateral side, and the other end of the FPC is passed between the lateral-side portion 105c of the housing 105 and the lateral side of the display panel 101, and is connected to the circuit board 102 at the back side of the display panel 101.

The circuit board 102 can be constituted of the FPD. In such a case, the heating elements 103, such as the driver IC, are mounted on the FPC.

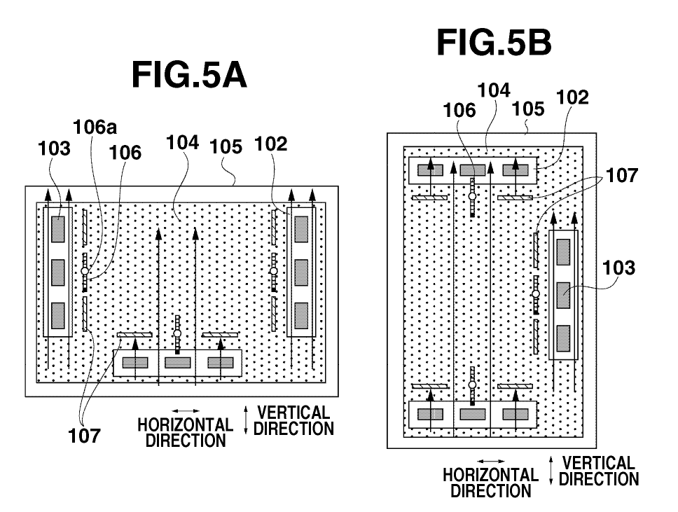

The heating elements 103 may be randomly located, or may be aligned in the horizontal and vertical directions as illustrated in FIGS. 1A to 1D, and FIGS. 5A and 5B.

The chassis 104 is used to fix the display panel 101 to the display module and can support the circuit board 102 or the FPC. The chassis 104 is usually made of metal. The chassis 104 is fixed to the display panel 101 with an adhesive or double-faced adhesive tape, but the fixing method is not limit to them. For example, the chassis 104 and the display panel 101 may be fastened together by screws or bolts and nuts, or the display panel 101 may be fitted into the chassis 104. In the present exemplary embodiment, the chassis 104 has the same shape as that of the back side of the display panel 101, however, the chassis 104 need not necessarily cover the whole back side of the display panel 101, and may be changed in thickness or shape in a range so long as the strength of the FPD 10 can be maintained.

The rotation plate 106 is provided between the display panel and the housing as the control unit to maintain a heat-releasing path to guide the air warmed up by the heating elements 103 along the vertical direction from the heating elements 103 regardless of the arrangement, i.e. the vertical arrangement or the horizontal arrangement of the FPD 10.

In the example illustrated in FIGS. 1A to 1D, the rotation plate 106 is formed of a plate material in a rectangle or almost rectangle shape. The rotation plate 106 is located so that the longitudinal direction (or a main surface) of the plate is perpendicular to the back side of the display panel 101 (or to the front surface of the chassis or to the back side portion 105a of the housing). The rotation plate 106 has a function to rotate in such a way that the longitudinal direction or the main surface of the rotation plate 106 may be maintained parallel with the vertical direction (in a direction along the vertical direction) according to the arrangement, i.e. the vertical arrangement or the horizontal arrangement, of the FPD 10.

A thickness T of the rotation plate 106 is defined by a length of the rotation plate 106 measured in a direction in which the back side portion 105a of the housing faces the back side of the chassis 104 or the display panel 101. A length L of the rotation plate 106 is defined by a length of the rotation plate 106 in the longitudinal direction (in a direction parallel with the vertical direction). A width W of the rotation plate 106 is defined as a length measured in a direction perpendicular to both the longitudinal direction and the thickness direction.

The rotating function of the rotation plate 106 can be realized, for example, by rotatably supporting the rotation plate 106 relative to the display module. Therefore, the control unit includes a rotary support shaft 106a which serves as a rotary shaft of the rotation plate 106 and supports the rotation plate 106 in the back side of the display panel as a component of the display module, or in the chassis fixed to the back side of the display panel. Or, the rotary support shaft 106a can be mounted to the housing.

It may be arranged that the center of gravity of the rotation plate 106 and the rotary support shaft 106a do not coincide with each other (do not intersect or are separated). Accordingly, the longitudinal direction of the rotation plate 106 (the main surface of the rotation plate 106) can always be made along the vertical direction by gravity regardless of the arrangement of the FPD 10 (the vertical arrangement or the horizontal arrangement).

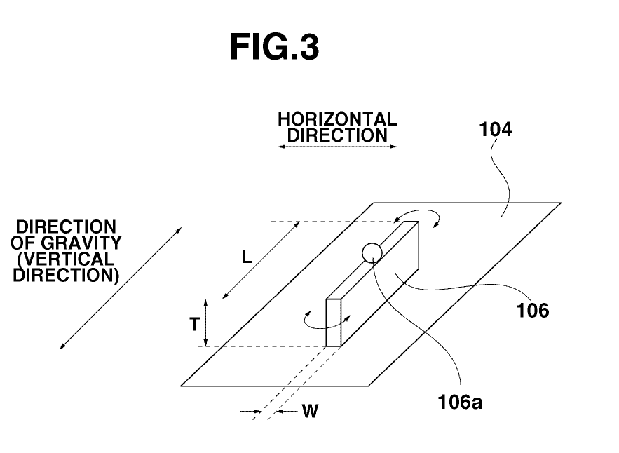

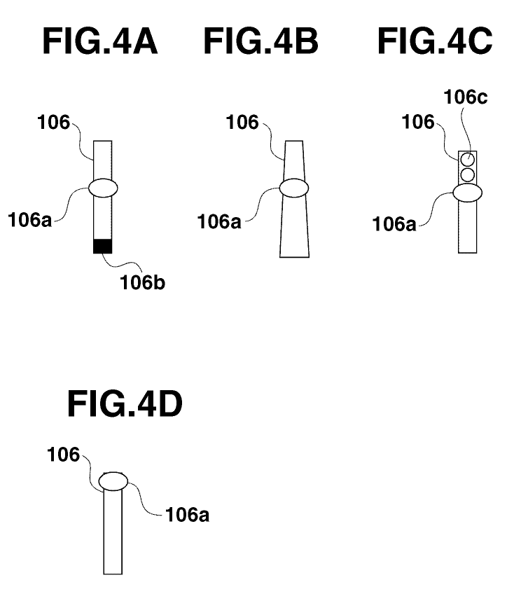

Examples of a case where the center of gravity of the rotation plate 106 does not coincide with the rotary support shaft 106a are illustrated in FIGS. 4A to 4D. FIGS. 4A to 4D are schematic plan views when the rotation plate 106 is seen from above the chassis 104 (from the direction of the back side) as illustrated in FIG. 3. FIG. 4A illustrates an example in which the rotary support shaft 106a is mounted in the middle of the rotation plate 106, and a weight is added to one end.

FIGS. 4B and 4C illustrate examples in which the volume of the rotation plate 106 from the rotary support shaft 106a to one end and that from the rotary support shaft 106a to the other end are varied. More specifically, in FIGS. 4B and 4C, the mass of a portion of the rotation plate 106 from the rotary support shaft 106a to one end is larger than the mass of a portion of the rotation plate 106 from the rotary support shaft 106a to the other end. In FIG. 4B, the width (cross section) at one end of the rotation plate 106 is larger than that of the other end, and the rotation plate 106 is in a trapezoidal shape. In FIG. 4C, the rotation plate 106 has a constant width, and holes (hollow portions) are formed between the rotary support shaft 106a and the other end. The structure in FIG. 4C can control increase in weight of the rotation plate 106 and contribute to reduction in weight of the whole FPD.

Instead of separating the rotary support shaft 106a from both ends of the rotation plate 106, as illustrated in FIG. 4D, the rotary support shaft 106a may be provided on either of the two ends of the rotation plate 106.

A sensor to detect the arrangement (the vertical arrangement or the horizontal arrangement) of the FPD 10 may be mounted, and the rotation plate 106 may be rotated actively according to a detection result by the sensor. For the above sensor, for example, a gravity sensor (an acceleration sensor to detect acceleration in the three axes direction) or a magnetic sensor may be used.

A material for the rotation plate 106 is preferably a resin or a synthetic resin superior in heat insulation performance, such as plastic, urethane or formed polystyrene. However, metal, such as aluminum alloy or iron may be used so long as desired temperature reduction effects can be obtained. The shape of the rotation plate 106 is preferably a rectangle with a thickness T of not less than 2 mm, however the rotation plate 106 is not limited to a specific shape if there is no problem from a viewpoint of heat releasing performance or the layout of the housing 105.

With the above described configuration, in the FPD 10 according to the first exemplary embodiment, the heat releasing path extending upward in the vertical direction from the heating elements 103 can be secured even if the arrangement of the FPD 10 is changed between the vertical arrangement and the horizontal arrangement. Thus, if the FPD 10 is rotated, the air that has absorbed heat generated by the heating elements 103 can move vertically upward without being blocked. Therefore, when the FPD 10 is set in the vertical arrangement, an amount of heat released from the heating elements 103 is increased compared with the conventional art. As a result, temperature rise and temperature variation in the heating elements 103 can be reduced than the conventional art. Since the temperature of the heating elements 103 can be decreased, the regulation in the high temperature side of the product operating temperature range for the FPD can be relaxed.

Since the variation in temperature of the heating elements 103 can be reduced, unevenness in brightness of a displayed image can be reduced. Because the heat from the heating elements 103 can be efficiently released, the need to add a heat-releasing member, such as a fan or a heat sink, or to increase the space around the heating elements 103 (between the housing and the display module) can be reduced. Therefore, the FPD compatible with the vertical and horizontal arrangements can be provided without significantly increasing the weight, cost, and volume of the FPD.

A concrete exemplary embodiment and a modification will be described below.

The FPD according to the first exemplary embodiment will be described with reference to FIGS. 1A to 1D, and FIGS. 4A to 4D. In the present exemplary embodiment, for the display panel 101, the FPD including the display screen with an aspect ratio of 16:9 is used.

The display panel 101 is electrically connected to the circuit board 102 by the FPC. The circuit board 102 is fixed to the chassis 104 by being screwed to the boss 130. The chassis 104 is made of a metal, which is glued to the back side of the display panel 101. The heating elements 103 are driver ICs, and are electrically connected to the circuit board 102. In the present exemplary embodiment, under the condition that the FPD 10 is set in the horizontal arrangement, a plurality of the heating elements 103 (in this case, three elements) is aligned along the vertical direction on the left and right sides. Thus, two sets of the heating elements 103 are provided.

Since the chassis 104 supports the display panel 101 and the circuit board 102, the heating elements 103 are also supported by the chassis 104.

The hosing 105 has a plurality of openings 105b formed therein. In the present exemplary embodiment, under the condition that the FPD 10 is in the horizontal arrangement or the vertical arrangement, the openings 105b are provided on an upper or a lower position in the vertical direction. More specifically, the openings 105b are arranged at the left, right, top, and bottom of the peripheral area of the backside portion 105a of the housing 105, except for the center area.

Bezels 105d of the housing 105 are provided outside of an image display area on the front side of the display panel 101. The bezels are mechanically and electrically connected to the display panel 101 putting a gasket therebetween. The gasket regulates an electrical potential on the front side of the display panel 101.

In the present exemplary embodiment, the FPD 10 includes two units, each consisting of three rotation plates 106. Under the condition that the FPD 10 is set in the horizontal arrangement, the first unit and the second unit are respectively located on the left side and the right side of the FPD 10.

Under the condition that the FPD 10 is set in the horizontal arrangement, the longitudinal directions of the respective rotation plates 106 that constitute the first unit are aligned in a line in the vertical direction. The second unit has the similar configuration to the one in the first unit. The first and second units are located closer to the center of the FPD 10 (to the center of the chassis 104) (or deeper in the inside of the FPD 10) than the two sets of the heating elements 103.

The rotary support shaft 106a which serves as a rotating shaft is provided at the center position in the longitudinal direction of each of the rotation plates 106. The rotary support shaft 106a is formed in a manner such that a through-hole (not illustrated) is formed in the center portion in the longitudinal direction of the rotation plate 106, the rotary support shaft 106a is inserted into the through-hole, and the rotation plate 106 is rotatably fixed to the boss of the metal chassis 104 with a bolt. A flat rectangular plate, which is 10 mm in thickness T, 50 mm in length L, and 2 mm in width W and formed of a high heat-resistant synthetic resin (plastic), is used for the rotation plate 106 (see FIG. 3). A weight 106b of aluminum alloy is attached to one end in the longitudinal direction of the rotation plate 106 (see FIG. 4A).

In this manner, the rotary support shaft 106a and the gravity center of the rotation plate 106 can be separated (can be made not to coincide). Consequently, a mechanism can be obtained in which the rotation plate 106 is naturally rotated by gravity so that the longitudinal direction of the rotation plate 106 may take the vertical direction. By the above configuration, regardless of the vertical arrangement or the horizontal arrangement of the FPD 10, the rotation plate 106 can always take a position in which the end portion with the weight 106b comes to the lower position in the vertical direction and the other end portion without the weight 106b comes to the upper position in the vertical direction.

In the above configuration, the rotation plate 106 rotates according to the rotation of the FPD 10, so that the heat-releasing paths can be always maintained in vertically upward direction. Therefore, the air that has absorbed the heat from the heating elements 103 can move vertically upward without being blocked by the rotation plates 106.

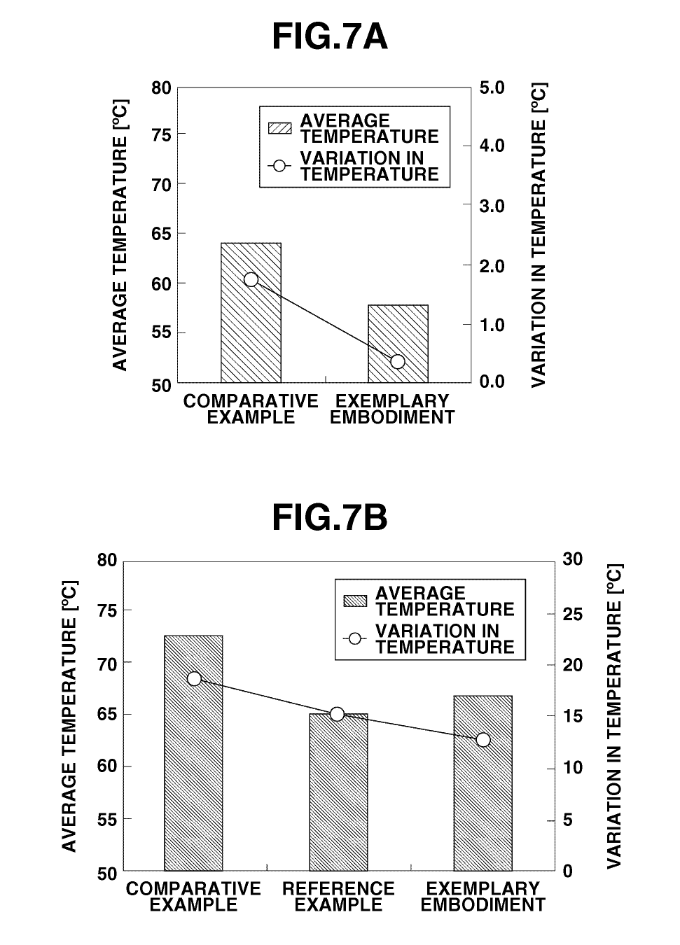

On the other hand, a comparative example is described. Under the condition that the FPD 10 was set in the horizontal arrangement, the rotation plates 106 were fixed to a position along the vertical direction, and then the FPD 10 was rotated to the vertical arrangement, and the display panel was driven. Measurement results are illustrated in FIG. 7A. Compared with the FPD in the comparative example, the FPD according to the present exemplary embodiment could lower the average temperature of the heating elements 103 about 6° C. and the temperature variation about 1.5° C. (see FIG. 7A).

An outline of an FPD according to a second exemplary embodiment of the present invention will be described with reference to FIGS. 5A and 5B. FIG. 5A illustrates the FPD in the horizontal arrangement, and FIG. 5B illustrates the FPD in the vertical arrangement. Those structures common to the first exemplary embodiment will not be described repeatedly.

In the second exemplary embodiment, the rotation plates 106 have the similar shape to those in the first exemplary embodiment. In contrast to the first exemplary embodiment, the control unit in the second exemplary embodiment includes flow rectifying plates 107 in addition to the rotation plates 106. Each flow rectifying plate 107 has the similar shape to the rectangle plate as the rotation plate 106 in the first exemplary embodiment. More specifically, the flow rectifying plate 107 is 10 mm in thickness T, 2 mm in width W, and 50 mm in length L. In the present exemplary embodiment, under the condition that the FPD 10 is set in the horizontal arrangement, two sets of a plurality of the heating elements 103 (in this case, one set includes three elements) are aligned in line on the left and right sides in the vertical direction, and one set of the plurality of the heating elements 103 (in this case, one set includes three element) are aligned in line in the horizontal direction.

In the present exemplary embodiment, the FPD 10 includes three units, each unit including two flow rectifying plates 107 and one rotation plate 106. Under the condition that the FPD 10 is set in the horizontal arrangement, the first unit and the second unit are mounted separately on the left side and the right side respectively. The third unit is mounted at a lower position of the FPD 10.

Under the condition that the FPD 10 is set in the horizontal arrangement, the flow rectifying plates 107 and the rotation plate 106 constituting the first unit are aligned in line, with the longitudinal directions of the plates 107 and 106 extending in the vertical direction. The second unit has the similar configuration to the first unit. The flow rectifying plates 107 and the rotation plate 106 constituting the third unit are aligned in line in the horizontal direction. The longitudinal directions of the flow rectifying plates 107 constituting the third unit are aligned in line in the horizontal direction. Under the condition that the FPD 10 is set in the horizontal arrangement, the rotation plate 106 constituting the third unit has its longitudinal direction extending in the vertical direction.

The first, second, and third units are each mounted closer to the center of the FPD 10 (or the center of the chassis) (or deeper in the inside of the FPD) than the three sets of the heating elements 103.

The flow rectifying plates 107 are inserted into slits provided in the metal chassis 104, and fixed to the metal chassis 104. As a material for the flow rectifying plates 107, a synthetic resin (plastic) having high heat insulation property is used.

In the second exemplary embodiment, the rotation plates 106 are mounted in the vicinity of regions which is higher in an amount of heat generation and heat generating density than in the surrounding areas, and the flow rectifying plates 107 are mounted in regions which is lower in an amount of heat generation and heat generating density than in the surrounding areas. More specifically, the rotation plate 106 is placed between a pair of the flow rectifying plates 107 in each unit. By this arrangement, an amount of air which flows upward in the vertical direction from the heating elements 103 near the rotation plates 106 increases, and the amount air which flows upward in the vertical direction from the heating elements 103 near the flow rectifying plates 107 can be limited. Therefore, the amount of heat released from the heating elements 103 can be adjusted according to the amount of heat generation and the heat generating density.

On the other hand, a comparative example is described below. The longitudinal directions of the rotation plats 106 of the FPD 10 in the second exemplary embodiment were fixed to the same direction as of the flow rectifying plates 107 placed on both sides of each rotation plate 106, the FPD 10 was set in the vertical arrangement, and the display panel was driven. Measurement results are illustrated in FIG. 7B. Compared with the FPD in the comparative example, the FPD in the second exemplary embodiment could lower the average temperature of the heating elements 103 about 5° C. and the temperature variation in the heating elements 103 about 6° C. As a reference example, when the flow rectifying plates 107 in the second exemplary embodiment were replaced by rotation plates 106 similar to those in the second exemplary embodiment, the temperature variation of the heating elements 103 became larger than that in the second exemplary embodiment, but the average temperature of the heating elements 103 could be reduced than that in the second exemplary embodiment.

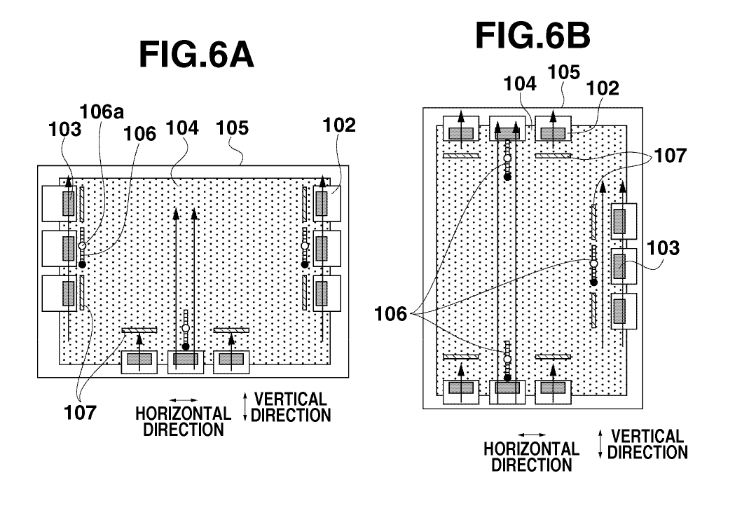

A general outline of an FPD according to a third exemplary embodiment is illustrated in FIGS. 6A and 6B. FIG. 6A illustrates the FPD in the horizontal arrangement, and FIG. 6B illustrates the FPD in the vertical arrangement.

In the third exemplary embodiment, the circuit board 102 is formed by the FPC by itself which is connected to the display panel 101. An IC driver as a heating element 103 is attached to an end of the FPC. Since other components in the present exemplary embodiment are similar to those in the second exemplary embodiment, description thereof is not repeated.

The FPC 102 has a structure in which an adhesion layer is formed on an insulation film (base film) with a thickness of 12 μm to 50 μm, and a conductor (copper) foil with a thickness of about 12 μm to 50 μm is further formed thereon. The FPC 102, except for terminal portions and soldered portions, is protected by being covered with an insulating material (a polyimide film or a photo solder resist film). By this structure, the FPC 102 can be repeatedly deformed by a small force, and can maintain its electric characteristics even when it is deformed.

In the FPC 102, outer lead bonding by an anisotropic conductive film is provided to the wiring of the display panel 101. The heating elements 103 are electrically connected to the FPC 102. The connection method can include a tape carrier package method and a chip on film method.

One end of the FPC 102 is electrically connected to the display panel 101. The FPC 102 extends outwardly from the outer periphery of the display panel 101, and while stretching towards the back side direction of the display panel 101, the FPC 102 is turned back to the inside of the display panel 101. The heating elements 103 are connected to the other end of the FPC 102. Accordingly, the FPC 102 and the heating elements 103 are located between the lateral side of the display panel 101 and the lateral-side portion 105c of the housing 105. The rotation plates 106 and the flow rectifying plates 107 is configured in a similar manner as in the second exemplary embodiment, so that a heat releasing function and a soaking function similar to that in the second exemplary embodiment can be obtained.

As a material for the flow rectifying plates 107, an aluminum alloy is used. Compared with a synthetic resin, the aluminum is higher in heat conductivity, and its heat insulation property is reduced. However, sufficient flow rectifying effect can be achieved, and it is possible to secure and block the heat releasing paths in the vertical direction. A distance of 40 mm is secured between the heating elements 103, the rotary support shafts 106a of the rotation plates 106, and the centers of the flow rectifying plates 107. Accordingly, influence of the material of the rotation plates 106 and the flow rectifying plates 107 can be reduced. Moreover, the temperature rise prevention and temperature variation reduction in the heating elements 103 can be obtained in a similar level to a case where a synthetic resin is used.

According to the configuration described above, like in the second exemplary embodiment, the temperature of the heating elements 103 can be reduced by about 5° C., and the temperature variation in the heating elements 103 can be reduced by about 6° C.

According to the present invention, since the air that has absorbed heat from the heating elements 103 can smoothly move upward in the vertical direction, the temperature of the heating elements 103 can be decreased regardless of whether the FPD is in the vertical arrangement or the horizontal arrangement. Therefore, regulations on the high temperature side in the product operating temperature range of FPDs can be eased.

According to the present invention, the variation in temperature of the heating elements 103 can be decreased whether the FPD is in the vertical arrangement or the horizontal arrangement. Consequently, since an electric resistance value among the heating elements 103 is equalized, the unevenness in brightness of the display panel 101 is decreased. Therefore, the image quality performance of the display panel can be improved.

According to the present invention, the heat from the heating elements 103 can be efficiently released regardless of whether the FPD is in the vertical arrangement or the horizontal arrangement. Thus, the need to add a heat releasing member, such as a fan or a heat sink, or to increase a space around the heating elements 103 can be reduced. Therefore, an FPD compatible with the vertical and horizontal arrangements which is free from malfunctioning and image degradation can be provided without greatly increasing the weight, cost, and volume of the FPD by reducing the temperature level and the temperature variation of the heating elements 103.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-035250 filed Feb. 19, 2010, which is hereby incorporated by reference herein in its entirety.

What is claimed is:

1. An image display apparatus, comprising:
a display panel;
a plurality of heating elements electrically connected to the display panel;
a housing configured to cover the display panel and the plurality of heating elements; and
a control unit provided between a back side of the display panel, wherein the back side is opposite to a display screen of the display panel and the housing, and configured to control air warmed up by the plurality of heating elements to flow in a vertical direction,
wherein the control unit is located closer to a center of the image display apparatus than the plurality of heating elements, and, in a condition that a normal line to the display screen intersects a vertical direction, the control unit includes a rotation plate that is rotated to maintain a longitudinal direction of the rotation plate parallel with the vertical direction according to rotation of the image display apparatus around the normal line as a rotation axis.

2. The image display apparatus according to claim 1, wherein the control unit includes a rotary support shaft configured to support the rotation plate and serve as a rotation axis of the rotation plate between one end and another end of the longitudinal direction of the rotation plate, and a gravity center of the rotation plate is located between the rotary support shaft of the rotation plate and the one end of the rotation plate.

3. The image display apparatus according to claim 2, wherein a mass of the rotation plate from the rotary support shaft to the one end of the rotation plate is larger than a mass of the rotation plate from the rotary support shaft to the another end of the rotation plate.

4. The image display apparatus according to claim 2, wherein the rotation plate includes a weight attached to the one end thereof.

5. The image display apparatus according to claim 2, wherein a cross-section area of the one end of the rotation plate is larger than a cross-section area of the another end thereof.

6. The image display apparatus according to claim 2, wherein a void is formed in a part of the rotation plate between the rotary support shaft and the one end of the rotation plate.

7. The image display apparatus according to claim 1, wherein the control unit includes a plurality of flow rectifying plates whose longitudinal direction is fixed along a direction in which the plurality of heating elements are aligned, and the rotation plate is provided between the plurality of flow rectifying plates.

8. The image display apparatus according to claim 1, wherein the heating element is any of a driver integrated circuit, a transistor, and a high-voltage power supply.
